(19) United States
(12) Patent Application Publication
(10) Pub. No.: US 2008/0019892 A1
(43) Pub. Date: Jan. 24, 2008

(54) Multimetal Oxide Containing Silver, Vanadium And A Phosphor Group Element And The Use Thereof

(75) Inventors: Samuel Neto, Mannheim (DE); Hartmut Hibst, Schriesheim (DE); Frank Rosowski, Mannheim (DE); Sebastian Storck, Mannheim (DE); Jurgen Zuhlke, Speyer (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/629,379

(22) PCT Filed: Jun. 14, 2005
(86) PCT No.: PCT/EP05/06366

§ 371 Date: Dec. 12, 2006

(30) Foreign Application Priority Data
Jun. 15, 2004 (DE) 10 2004 028 930.1

(51) Int. Cl. C01G 31/00; B01J 23/00

(52) U.S. Cl. 423/62; 502/300

(57) ABSTRACT

Multimetal oxides corresponding to the general formula (I), processes for their preparation, precatalysts containing such oxides and catalysts made therefrom for gas phase partial oxidation of hydrocarbons:
Ag_{a-c}Q_{b}M_{c}V₁₂O_{d}.eH₂O (I) wherein a represents a number having a value of 5 to 9; Q represents an element selected from the group consisting of P, As, Sb, Bi and mixtures thereof; b represents a number having a value of 0.2 to 3; M represents a metal selected from the group consisting of Li, Na, K, Rb, Cs, Tl, Mg, Ca, Sr, Ba, Cu, Zn, Cd, Pb, Cr, Au, Al, Fe, Co, Ni, Ce, Mn, Nb, W, Ta, Mo and mixtures thereof; c represents a number having a value of less than 1; d represents a number having a value of which is determined by the valency and frequency of Ag, Q, M and V in the formula (I); and e represents a number having a value of 0 to 20; wherein the multimetal oxide has a crystal structure wherein its powder X-ray diffractogram includes reflections at at least 5 interplanar spacings selected from the group of 7.13 Å, 5.52 Å, 5.14 Å, 3.57 Å, 3.25 Å, 2.83 Å, 2.79 Å, 2.73 Å, 2.23 Å and 1.71 Å, each interplanar spacing value±0.04 Å.

The invention relates to a multimetal oxide comprising silver, vanadium and an element of the phosphorus group, to its use for preparing precatalysts and catalysts for the gas phase partial oxidation of aromatic hydrocarbons, to the thus obtained precatalysts and to a process for preparing the multimetal oxide or the catalysts.

As is well known, a multitude of aldehydes, carboxylic acids and/or carboxylic anhydrides is prepared industrially by the catalytic gas phase oxidation of aromatic hydrocarbons such as benzene, o-, m- or p-xylene, naphthalene, toluene, durene (1,2,4,5-tetramethylbenzene) or picoline in fixed bed reactors, preferably tube bundle reactors. Depending on the starting material, for example, benzaldehyde, benzoic acid, maleic anhydride, phthalic anhydride, isophthalic acid, terephthalic acid, pyromellitic anhydride or nicotinic acid is obtained. To this end, a mixture of a molecular oxygen-containing gas, for example air, and the starting material to be oxidized are passed through a multitude of tubes disposed in a reactor in which there is a bed of at least one catalyst.

WO 00/27753, WO 01/85337 and the application DE 10334132.3 having an earlier priority date than the present application describe multimetal oxides comprising silver oxide and vanadium oxide, and their use for preparing catalysts for the partial oxidation of aromatic hydrocarbons. The catalytically active constituents of the catalytically active composition of such catalysts are what is known as silver-vanadium oxide bronzes. The preparation, illustrated in these documents, of the multimetal oxides starts from a suspension of vanadium pentoxide which is reacted with a solution of a silver compound and, if appropriate, further components. However, the handling of solid suspensions is undesired in industrial processes, since the suspensions tend to inhomogeneities, to sedimentation of the solid, to blockage of pipelines and pumps and the like.

It is an object of the present invention to provide novel readily obtainable multimetal oxides for preparing catalysts for the partial oxidation of aromatic hydrocarbons. The catalysts which can be prepared from the multimetal oxides should have similar or better activities and selectivities than the catalysts prepared according to the prior art.

According to the invention, the object is achieved by multimetal oxides of the general formula (I),
Ag_{a-c}Q_{b}M_{c}V₁₂O_{d}.eH₂O (I),
where
a has a value from 3 to 10,
Q is an element selected from P, As, Sb and/or Bi,
b has a value from 0.2 to 3,
M is a metal selected from Li, Na, K, Rb, Cs, TI, Mg, Ca, Sr, Ba, Cu, Zn, Cd, Pb, Cr, Au, Al, Fe, Co, Ni, Ce, Mn, Nb, W, Ta and/or Mo,
c has a value from 0 to 3, with the proviso that (a-c)≧0. 1,
d is a number which is determined by the valency and frequency of the elements in the formula (I) other than oxygen, and
e has a value from 0 to 20,
   which is present in a crystal structure whose powder X-ray diffractogram is characterized by reflections at at least 5, preferably at least 7, especially at least 9, interplanar spacings selected from d=7.13; 5.52; 5.14; 3.57; 3.25; 2.83; 2.79; 2.73; 2.23 and 1.71 Å (±0.04 Å). Most preferably, the powder X-ray diffractogram is characterized by reflections at all of the interplanar spacings specified.

In the present application, the X-ray reflections are specified in the form of the interplanar spacings d[Å] which are independent of the wavelength of the X-radiation used and can be calculated from the reflection angle measured by means of the Bragg equation.

In general, the powder X-ray diffractogram of the inventive multimetal oxide has the 10 characteristic reflections listed in Table 1.

TABLE 1

| | d (±0.04) | Iᵣₑₗ |
|---|---|---|
| Reflections | [Å] | [%] |
| 1 | 7.13 | 18.6 |
| 2 | 5.52 | 19.3 |
| 3 | 5.14 | 43.7 |
| 4 | 3.57 | 33.0 |
| 5 | 3.25 | 73.4 |
| 6 | 2.83 | 64.1 |
| 7 | 2.79 | 100 |
| 8 | 2.73 | 85.1 |
| 9 | 2.23 | 31.4 |
| 10 | 1.71 | 46.4 |

Depending on the degree of crystallinity and the texture of the resulting crystals of the multimetal oxide, there may be weakening of the intensity of the reflections in the powder X-ray diffractogram which may occur to such an extent that individual reflections of relatively weak intensity can no longer be detected in the powder X-ray diffractogram. Individual reflections of relatively weak intensity may therefore be absent or the intensity ratio in the powder X-ray diffractogram may be altered. At least 5, preferably at least 7, more preferably at least 9 and most preferably all of the reflections listed in Table 1 adequately characterize a multimetal oxide of the formula (I). The presence of all 10 reflections in the powder X-ray diffractogram is an indication that a multimetal oxide is in accordance with the invention and has particularly high crystallinity.

It is self-evident to those skilled in the art that the inventive multimetal oxides, in addition to the characteristic reflections reproduced above, may have further reflections. Moreover, mixtures of the inventive multimetal oxides with other crystalline compounds have additional reflections. Such mixtures of the multimetal oxide with other crystalline compounds may be prepared deliberately by mixing the multimetal oxide with such compounds, which are formed in the preparation of the multimetal oxides by incomplete conversion of the starting materials or result from impurities.

In the multimetal oxide of the formula (I), the variable a preferably has a value from 5 to 9 and more preferably from 6.5 to 7.5. The value of the variable b is preferably from 0.5 to 1.5 and more preferably from 0.8 to 1.2. The value of the variable c is preferably less than 1 and is more preferably 0. It is especially preferred that the variable a has a value of from 5 to 9 and the variable c has the value 0.

In a very particularly preferred embodiment, a has a value from 5 to 9, b a value from 0.5 to 1.5 and c the value 0.

In the formula (I), Q is in particular the element P.

The metal M in the formula (I) is in particular selected from Na, K, Rb, TI, Au, Cu, Ce, Mn; M is especially Ce or Mn.

The BET specific surface area, measured according to DIN 66 131, which is based on the “Recommendations 1984” of IUPAC International Union of Pure and Applied Chemistry (see Pure & Appl. Chem. 57, 603 (1985)), is generally more than 1 m²/g, in particular from 3 to 100 m²/g, and especially from 10 to 80 m²/g.

The inventive multimetal oxides are prepared in particular by a process in which
(i) an aqueous solution of at least one water-soluble vanadium compound is prepared; and
(ii) the solution of the vanadium compound is combined with a solution of a silver salt and a source of the element Q, and also, if appropriate, a source of the metal M.

Depending upon the desired chemical composition of the multimetal oxide of the formula (I), it is prepared by reacting together the amounts, arising from a, b and c of the formula (I), of vanadium compound, silver salt and source of the element Q and also, if appropriate, the source of the metal M. The inventive multimetal oxide is obtained on completion of reaction.

Useful water-soluble vanadium compounds are in particular monovanadates (Me^{I}₂HVO₄), divanadates (Me^{I}₃HV₂O₇), metavanadates (Me^{I}VO₃), decavanadates (Me^{I}₆V₁₀O₂₈, Me^{I}₅HV₁₀O₂₈ and Me^{I}₄H₂V₁₀O₂₈) and the dodecavanadates having the [V₁₂O₃₂]⁴⁻ anion, where Me^{I} in each case is one monovalent cation equivalent, for example an alkali metal ion or ammonium ion, in particular the metavanadates and especially NaVO₃ and/or (NH₄)VO₃. Such water-soluble vanadium compounds are commercially available or can be obtained by reacting V₂O₅ with alkali metal hydroxides. Soluble vanadium compounds may also be obtained by reacting V₂O₅ with reducing agents.

The solution of the silver salt may be prepared in water or a water-miscible organic solvent, such as alcohols, e.g. methanol, polyols, e.g. ethylene glycol, or polyethers, e.g ethylene glycol dimethyl ether. Preference is given to using water as the solvent. The silver salt used is preferably silver nitrate, but it is likewise possible to use other soluble silver salts, e.g silver acetate, silver perchlorate or silver fluoride.

The element or elements Q from the group P, As, Sb and/or Bi may be used in elemental form or as oxides or hydroxides. In particular, they are used in the form of their soluble compounds, more preferably their organic or inorganic water-soluble compounds. Very particular preference among these is given to to the inorganic water-soluble compounds, in particular the alkali metal and ammonium salts and especially the semineutralized or free acids of these elements, for example phosphoric acid, arsenic acid, antimonic acid, the ammonium hydrogenphosphates, arsenates, antimonates and bismuthates, and the alkali metal hydrogen phosphates, arsenates, antimonates and bismuthates. Very particular preference is given to using phosphorus alone as the element Q, in particular in the form of phosphoric acid, phosphorous acid, hypophosphorous acid, diammonium hydrogenphosphate, ammonium dihydrogenphosphate or phosphoric esters, especially as ammonium dihydrogenphosphate or phosphoric acid and very especially as phosphoric acid.

Where they are also used, the salts of the metal component M selected are generally those which are soluble in the solvent used, in particular the water-soluble salts, for example perchlorates, carboxylates, acetates and nitrates, in particular acetates and nitrates, of the metal component M in question.

To carry out the process according to the invention for preparing a multimetal oxide of the formula (I), the solution of the vanadium compound can be combined and reacted with the solution of the silver salt and of the source of the element Q, and also, if appropriate, of the source of the metal M.

Alternatively, the solution of the vanadium compound is reacted with a source of the element Q and also, if appropriate, a source of the metal M, and the resulting solution is combined with the solution of the silver salt.

The reaction of the vanadium compound with the source of the element Q and, if appropriate, the compound of the metal component M in the presence or absence of the silver compound may generally be carried out at room temperature or at elevated temperature. In general, the reaction is undertaken at temperatures of from 20 to 375° C., preferably from 20 to 100° C. and more preferably from 60 to 100° C. When the temperature of the reaction is above the temperature of the boiling point of the solvent used, the reaction is appropriately performed in a pressure vessel under the autogenous pressure of the reaction system. Preference is given to selecting the reaction conditions in such a way that the reaction can be carried out at atmospheric pressure.

The duration of this reaction may, depending upon the type of the starting materials used and the temperature conditions employed, be from 10 minutes to 3 days. It is possible to prolong the reaction time of the reaction, for example to 5 days or more. In general, the reaction is carried out over a period of from 6 to 24 hours.

The thus formed inventive multimetal oxide may be isolated from the reaction mixture and stored until further use. The multimetal oxide can be isolated, for example, by filtering off the suspension and drying the resulting solid, in which case the drying may be carried out either in conventional dryers or else, for example, in freeze-dryers. The drying of the resulting multimetal suspension is particularly advantageously carried out by means of spray-drying. It may be advantageous to wash the multimetal oxide obtained in the reaction to free it of salts before drying it.

The spray-drying is generally undertaken under atmospheric pressure or reduced pressure. Depending upon the pressure employed and the solvent used, the inlet temperature of the drying gas is determined; generally, the drying gas used is air, but it is also possible to use other drying gases such as nitrogen or argon. The inlet temperature of the drying gas into the spray-dryer is advantageously selected in such a way that the outlet temperature of the drying gas cooled by evaporation of the solvent does not exceed 200° C. for a prolonged period. In general, the outlet temperature of the drying gas is set to from 50 to 150° C., preferably from 80 to 140° C.

In a particularly preferred embodiment, the solution of the vanadium compound is reacted with the source of the element Q and, if appropriate, the source of the metal M, a stream of the resulting solution is mixed continuously with a stream of the silver salt solution and the mixed stream is spray-dried.

If storage of the multimetal oxide is not intended, the resulting multimetal oxide suspension may also be fed to further use without preceding isolation and drying of the multimetal oxide, for example to prepare the inventive precatalysts by coating.

The inventive multimetal oxides are used as a precursor compound for preparing the catalytically active composition of catalysts, as used for the gas phase oxidation of aromatic hydrocarbons to aldehydes, carboxylic acids and/or carboxylic anhydrides using a molecular oxygen-containing gas.

Even though the inventive multimetal oxides are used preferentially for the preparation of coated catalysts, they may also be used as a precursor compound for the preparation of conventional supported catalysts or of unsupported catalysts, i.e. catalysts which do not contain any support material.

Catalysts for the partial oxidation of aromatic hydrocarbons to aldehydes, carboxylic acids and/or carboxylic anhydrides are prepared from the inventive multimetal oxides appropriately via the stage of an inventive “precatalyst” which can be stored and handled as such and from which the active catalyst is either prepared by thermal treatment or can be obtained in situ in the oxidation reactor under the conditions of the oxidation reaction.

The precatalyst is thus a precursor of the catalyst which can be converted to a catalyst and consists of an inert nonporous support material and at least one layer applied thereto which comprises a multimetal oxide of the formula (I). This layer is preferably applied to the support material in the form of a coating and comprises preferably from 30 to 100% by weight, in particular from 50 to 100% by weight, based on the total weight of this layer, of a multimetal oxide of the formula (I). More preferably, the layer consists entirely of a multimetal oxide of the formula (I).

When, apart from the multimetal oxide of the formula (I), the catalytically active layer also contains further components, these may be, for example, inert materials such as silicon carbide or steatite, or else other known vanadium oxide/anatase-based catalysts for the oxidation of aromatic hydrocarbons to aldehydes, carboxylic acids and/or carboxylic anhydrides. The precatalyst preferably contains from 5 to 25% by weight, based on the total weight of the precatalyst, of multimetal oxide.

The inert nonporous support material used for the inventive precatalysts may be virtually any support materials of the prior art, as advantageously find use in the preparation of coated catalysts for the oxidation of aromatic hydrocarbons to aldehydes, carboxylic acids and/or carboxylic anhydrides, for example quartz (SiO₂), porcelain, magnesium oxide, tin dioxide, silicon carbide, rutile, clay (Al₂O₃), aluminum silicate, steatite (magnesium silicate), zirconium silicate, cerium silicate or mixtures of these support materials. The term “nonporous” is to be understood in the sense of “nonporous down to an industrially ineffective amount of pores”, since it is unavoidable in industry that a small number of pores are present in the support material which should ideally not contain any pores. Advantageous support materials which should be emphasized are in particular steatite and silicon carbide. The form of the support material is generally not critical for the inventive precatalysts. For example, catalyst supports may be used in the form of spheres, rings, tablets, spirals, tubes, extrudates or spall. The dimensions of these catalyst supports correspond to the catalyst supports typically used for the production of coated catalysts for the gas phase partial oxidation of aromatic hydrocarbons. The aforementioned support materials may also be mixed by adding in powder form with the catalytically active composition of the inventive coated precatalysts.

To coat the inert support material with the inventive multimetal oxide, it is possible in principle to employ known prior art methods. For example, the suspension obtained in the reaction of the vanadium compound with the source of the element Q, the silver compound and, if appropriate, the compound of the metal component M may, in accordance with the process of DE-A 16 92 938 and DE-A 17 69 998, be sprayed in a heated coating drum at elevated temperature onto the catalyst support consisting of inert support material until the desired amount of multimetal oxide, based on the total weight of the precatalyst, has been attained. Instead of coating drums, it is also possible to use, in a similar manner to DE-A 21 06 796, fluidized bed coaters, as described in DE-A 12 80 756, for the application of the inventive multimetal oxide coating to the catalyst support. Instead of the resulting suspension of the multimetal oxide, it is possible, with particular preference, to use a slurry of the powder, obtained after isolation and drying, of the inventive multimetal oxide in this coating process. In a similar manner to EP-A 744 214, it is possible to add to the suspension of the inventive multimetal oxide, as is formed in its preparation, or to a slurry of a powder of the inventive, dried multimetal oxide in water, an organic solvent such as higher alcohols, polyhydric alcohols, e.g. ethylene glycol, 1,4-butanediol or glycerol, dimethylformamide, dimethylacetamide, dimethyl sulfoxide, N-methylpyrrolidone or cyclic ureas such as N,N′-dimethylethyleneurea or N,N′-dimethylpropyleneurea, or in mixtures of these organic solvents with water, organic binders, preferably copolymers, dissolved or advantageously in the form of an aqueous dispersion, and the binder contents employed are generally from 10 to 20% by weight, based on the solids content of the suspension or slurry of the inventive multimetal oxide. Suitable binders are, for example, vinyl acetate/vinyl laurate, vinyl acetate/acrylate, styrene/acrylate, vinyl acetate/maleate or vinyl acetate/ethylene copolymers. When the binders are organic copolymer polyesters, for example based on acrylate/dicarboxylic anhydride/alkanolamine, and are added in a solution in an organic solvent of the slurry of the inventive multimetal oxide, it is possible, in a similar manner to the teaching of DE-A 198 23 262.4, to reduce the content of binder to from 1 to 10% by weight, based on the solids content of the suspension or slurry.

In the coating of the catalyst support with the inventive multimetal oxides, coating temperatures of from 20 to 500° C. are generally employed, in which case the coating in the coating apparatus can be effected under atmospheric pressure or under reduced pressure. To prepare the inventive precatalysts, the coating is generally carried out at from 0° C. to 200° C., preferably from 20 to 150° C., in particular at from room temperature to 100° C. In the coating of the catalyst support with a moist suspension of the inventive multimetal oxides, it may be appropriate to employ higher coating temperatures, for example temperatures of from 200 to 500° C. At the aforementioned lower temperatures, it is possible, when using a polymeric binder in the coating, for a portion of the binder to remain in the layer applied to the catalyst support.

In the later conversion of the precatalyst to a coated catalyst by thermal treatment at temperatures from above 200 to 500° C., the binder escapes by thermal decomposition and/or combustion from the applied layer. The conversion of the precatalyst to a coated catalyst can also be effected by thermal treatment at temperatures above 500° C., for example at temperatures up to 650° C.; preference is given to carrying out the thermal treatment at temperatures of from above 200 to 500° C., in particular at from 300 to 450° C.

Above 200° C., especially at temperatures of more than 300° C., the inventive multimetal oxides decompose to form catalytically active silver-vanadium oxide bronzes. Silver-vanadium oxide bronzes refer to silver-vanadium oxide compounds having an atomic Ag:V ratio of less than 1. These are generally semiconductive or metallically conductive oxidic shaped bodies which crystallize preferably in sheet or tunnel structures, and the vanadium is present in the [V₂O₅] host lattice partly reduced to V(IV).

At appropriately high coating temperatures, it is possible that a portion of the multimetal oxides applied to the catalyst support is decomposed to catalytically active silver-vanadium oxide bronzes and/or silver-vanadium oxide compounds whose structure has not been solved by crystallography but which can be converted to the silver-vanadium oxide bronzes mentioned. At coating temperatures of from 300 to 500° C., this decomposition proceeds virtually to completion, so that, in the case of a coating at from 300 to 500° C., the finished coated catalysts can be obtained without passing through the preliminary stage of the precatalyst.

In the thermal coating of the inventive precatalysts at temperatures of from above 200 to 650° C., preferably at from above 250 to 500° C., in particular at from 300 to 450° C., the multimetal oxides present in the precatalyst decompose to silver-vanadium oxide bronzes. This conversion of the inventive multimetal oxides present in the precatalyst to silver-vanadium oxide bronzes also takes place in particular in situ in the reactor for the gas phase partial oxidation of aromatic hydrocarbons to aldehydes, carboxylic acids and/or carboxylic anhydrides, for example in the reactor for preparing phthalic anhydride from o-xylene and/or naphthalene, at the temperatures of from 300 to 450° C. generally employed, when, instead of a finished coated catalyst, an inventive precatalyst is used in this reaction. Up to the end of the conversion of the inventive multimetal oxide to the silver-vanadium oxide bronzes, a steady rise in the selectivity of the coated catalysts can generally be observed. The silver-vanadium oxides which form are thus a catalytically active constituent of the catalytically active layer of the finished coated catalyst.

The thermal conversion of the inventive multimetal oxides to silver-vanadium oxide bronzes proceeds via a series of reduction and oxidation reactions which individually are not yet understood.

Another means of preparing a coated catalyst consists in the thermal treatment of the inventive multimetal oxide powder at temperatures of from above 200 to 650° C. and the coating of the inert nonporous catalyst support, if appropriate with addition of a binder, with the silver-vanadium oxide bronze thus obtained.

Particularly advantageously the coated catalysts may be obtained from the inventive precatalyst in one stage or, if appropriate, after a thermal treatment in the course of or after the coating of the catalyst support, in a plurality of stages, in particular in one stage, in each case in situ in the oxidation reactor under the conditions of the oxidation of the aromatic hydrocarbons to aldehydes, carboxylic acids and/or carboxylic anhydrides.

The invention thus further provides a process for preparing catalysts for the gas phase partial oxidation of aromatic hydrocarbons, consisting of an inert nonporous support and at least one layer applied thereto which comprises a silver-vanadium oxide bronze as a catalytically active composition, by heat treatment of the inventive precatalyst.

The thus obtained catalysts are used for the partial oxidation of aromatic or heteroaromatic hydrocarbons to aldehydes, carboxylic acids and/or carboxylic anhydrides, in particular for the gas phase partial oxidation of o-xylene and/or naphthalene to phthalic anhydride, of toluene to benzoic acid and/or benzaldehyde, or of methylpyridines such as β-picoline to pyridinecarboxylic acids such as nicotinic acid, using a molecular oxygen-containing gas. For this purpose, the catalysts may be used alone or in combination with other catalysts having different activity, for example catalysts based on vanadium oxide/anatase, in which case the different catalysts may generally be disposed in the reactor in separate catalyst beds which may be disposed in one or more fixed catalyst beds.

The BET surface areas, crystallographic structures and vanadium oxidation states of the silver-vanadium oxide bronzes which can be prepared from the inventive multimetal oxides are substantially comparable to those of the known silver-vanadium oxide bronzes.

### EXAMPLES

A Preparation of Multimetal Oxides

A.1 Ag_{0,73}V₂Oₓ (Comparative Example)

102 g of V₂O₅ (0.56 mol) were added with stirring to 7 l of demineralized water at 60° C. An aqueous solution of 69.5 g of AgNO₃ (0.409 mol) in 1 l of water was added with further stirring to the resulting orange-colored suspension. Subsequently, the temperature of the resulting suspension was increased to 90° C. within 2 hours and the mixture was stirred at this temperature for 24 hours. Afterward, the resulting dark brown suspension was cooled and spray-dried (inlet temperature (air)=350° C., outlet temperature (air)=110° C.).

The resulting powder had a BET specific surface area of 56 m²/g and a vanadium oxidation state of 5. A powder X-ray diffractogram of the resulting powder was recorded with the aid of a Siemens D 5000 diffractometer using Cu-Kα radiation (40 kV, 30 mA). The diffractometer was equipped with an automatic primary and secondary aperture system and a secondary monochromator and scintillation detector. From the powder X-ray diffractogram, the following interplanar spacings d [Å] with the accompanying relative intensities Iᵣₑₗ [%] were determined: 15.04 (11.9), 11.99 (8.5), 10.66 (15.1), 5.05 (12.5), 4.35 (23), 3.85 (16.9), 3.41 (62.6), 3.09 (55.1), 3.02 (100), 2.58 (23.8), 2.48 (27.7), 2.42 (25.1), 2.36 (34.2), 2.04 (26.4), 1.93 (33.2), 1.80 (35.1), 1.55 (37.8).

A.2 Ag₇PV₁₂O₃₆.xH₂O (Inventive)

144.4 g of ammonium metavanadate (1.2 mol) were added with stirring to 6 l of demineralized water at 30° C. and dissolved at 90° C. 11.5 g of phosphoric acid (0.1 mol, 85% by weight) and an aqueous solution of 118.9 g of AgNO₃ (0.7 mol) in 0.21 of water were added with further stirring to the resulting yellow-colored solution. Subsequently, the temperature of the resulting red-brown suspension was increased to 90° C. within 2 hours and the mixture was stirred at this temperature for 10 hours. Afterward, the resulting dark brown suspension was cooled and spray-dried (inlet temperature (air)=370° C., outlet temperature (air)=100° C.).

The resulting powder had a BET specific surface area of 14 m²/g and a vanadium oxidation state of 5. A powder X-ray diffractogram of the resulting powder was recorded. From the powder X-ray diffractogram, the following interplanar spacings d [Å±0.04] with the accompanying relative intensities Iᵣₑₗ [%] were determined: 7.13 (18.6), 5.52 (19.3), 5.14 (43.7), 3.57 (33.0), 3.25 (73.4), 2.83 (64.1), 2.79 (100), 2.73 (85.1), 2.23 (31.4), 1.71 (46.4).

A.3 Ag₇PV₁₂O₃₆.xH₂O (Inventive)

144.4 g of ammonium metavanadate (1.20 mol) were added with stirring to 5 l of demineralized water at 30° C. and dissolved at 90° C. 11.5 g of phosphoric acid (0.1 mol, 85% by weight) were added with further stirring to the resulting yellow-colored solution. Subsequently, the temperature of the resulting red-brown solution was increased to 90° C. within 2 hours and the mixture was stirred at this temperature for 5 hours. Afterward, the resulting red-brown solution was cooled. A second solution of 118.9 g of AgNO₃ (0.7 mol) in 5 l of water was prepared separately. Both solutions were spray-dried together (inlet temperature (air)=370° C., outlet temperature (air)=100° C.) by means of a hose mixer.

The resulting powder had a BET specific surface area of 24 m²/g and a vanadium oxidation state of 5. A powder X-ray diffractogram was recorded of the resulting powder. From the powder X-ray diffractogram, the following interplanar spacings d [Å±0.04] with the accompanying relative intensities Iᵣₑₗ [%] were determined: 7.13 (17.9), 5.53 (15.0), 5.15 (48.4), 3.57 (34.7), 3.25 (80.2), 2.83 (64.2), 2.79 (100), 2.73 (88.8), 2.23 (30.1), 1.72 (53.2).

B Preparation of Precatalysts

For the use, demonstrated under C, of the multimetal oxides for the partial oxidation of aromatic hydrocarbons, the powders A1, A2 and A3 prepared were applied as follows to magnesium silicate spheres: 300 g of steatite spheres having a diameter of from 3.5 to 4 mm were coated in a coating drum at 20° C. over 20 min with 40 g of the particular powder and 4.4 g of oxalic acid with addition of 35.3 g of a mixture comprising 60% by weight of water and 40% by weight of glycerol and subsequently dried. The weight of the thus applied catalytically active composition, determined on a sample of the resulting precatalyst, after heat treatment at 400° C. for one hour, was 10% by weight, based on the total weight of the finished catalyst.

C Oxidation of o-xylene to phthalic anhydride

The precatalysts A.1, A.2 and A.3, prepared according to B (coated steatite spheres) were introduced up to a bed length of 66 cm each into an 80 cm-long iron tube having an internal width of 16 mm. The iron tubes were surrounded by an electrical heating mantle for temperature control. Through the tubes from top to bottom, 360 l (STP)/h of air at 350° C. laden with 98.5% by weight o-xylene were passed from top to bottom through the tube at a loading of 60 g of o-xylene/m³ (STP) of air. Table 2 which follows summarizes the results obtained.

TABLE 2

| | | | | COₓ |
|---|---|---|---|---|
| | | | Conver- | selec- |
| | | Phase | sion | tivity¹⁾ |
| No. | Catalyst | (P-XRD) | (mol %) | (mol %) |
| 1 | comparative catalyst | Ag_{0.73}V₂Oₓ | 39 | 12 |
| | (from multimetal oxide of A.1) | | | |
| 2 | inventive catalyst | Ag₇PV₁₂O₃₆ | 42 | 11 |
| | (from multimetal oxide of A.2) | | | |
| 3 | inventive catalyst | Ag₇PV₁₂O₃₆ | 40 | 11 |
| | (from multimetal oxide of A.3) | | | |

¹⁾“COₓ selectivity” corresponds to the proportion of the xylene converted to combustion products (CO, CO₂); the residual selectivity to 100% corresponds to the proportion of the o-xylene converted to the product of value, phthalic anhydride, and the intermediates, o-tolylaldehyde, o-toluic acid and phthalide, and also by-products such as maleic anhydride, citraconic anhydride and benzoic acid.

A deinstalled sample of catalyst A.1 was used to determine a BET surface area of the active composition of 6.7 m²/g and a vanadium oxidation state of 4.63. From the powder X-ray diffractogram, the following interplanar spacings d [Å] with the accompanying relative intensities Iᵣₑₗ [%] were determined: 4.85 (9.8), 3.50 (14.8), 3.25 (39.9), 2.93 (100), 2.78 (36.2), 2.55 (35.3), 2.43 (18.6), 1.97 (15.2), 1.95 (28.1), 1.86 (16.5), 1.83 (37.5), 1.52 (23.5).

The deinstalled samples of catalysts A.2 and A.3 exhibit similar powder X-ray diffractograms, the BET surface area is in each case approx. 6 m²/g and the vanadium oxidation state is 4.69.

1-13. (canceled)

14. A multimetal oxide corresponding to the general formula (I):
Ag_{a-c}Q_{b}M_{c}V₁₂O_{d}.eH₂O (I)
wherein a represents a number having a value of 5 to 9; Q represents an element selected from the group consisting of P, As, Sb, Bi and mixtures thereof; b represents a number having a value of 0.2 to 3; M represents a metal selected from the group consisting of Li, Na, K, Rb, Cs, Ti, Mg, Ca, Sr, Ba, Cu, Zn, Cd, Pb, Cr, Au, Al, Fe, Co, Ni, Ce, Mn, Nb, W, Ta, Mo and mixtures thereof; c represents a number having a value of less than 1; d represents a number having a value of which is determined by the valency and frequency of Ag, Q, M and V in the formula (I); and e represents a number having a value of 0 to 20; wherein the multimetal oxide has a crystal structure wherein its powder X-ray diffractogram includes reflections at at least 5 interplanar spacings selected from the group of 7.13 Å, 5.52 Å, 5.14 Å, 3.57 Å, 3.25 Å, 2.83 Å, 2.79 Å, 2.73 Å, 2.23 Å and 1.71 Å, each interplanar spacing value±0.04 Å.

15. The multimetal oxide according to claim 14, wherein c represents zero.

16. The multimetal oxide according to claim 14, wherein b represents a number having a value of 0.5 to 1.5.

17. The multimetal oxide according to claim 15, wherein b represents a number having a value of 0.5 to 1.5.

18. The multimetal oxide according to claim 14, wherein Q represents phosphorus.

19. The multimetal oxide according to claim 15, wherein Q represents phosphorus.

20. The multimetal oxide according to claim 16, wherein Q represents phosphorus.

21. The multimetal oxide according to claim 17, wherein Q represents phosphorus.

22. The multimetal oxide according to claim 14, having a BET specific surface area of from 3 to 100 m²/g.

23. The multimetal oxide according to claim 15, having a BET specific surface area of from 3 to 100 m²/g.

24. The multimetal oxide according to claim 16, having a BET specific surface area of from 3 to 100 m²/g.

25. The multimetal oxide according to claim 18, having a BET specific surface area of from 3 to 100 m²/g.

26. A process for preparing a multimetal oxide according to claim 14, the process comprising:
(a) providing an aqueous solution of at least one water-soluble vanadium compound; and
(b) reacting the aqueous solution of the at least one water-soluble vanadium compound with (i) a solution of a silver salt, (ii) a source of Q and, where c does not equal zero, (iii) a source of M.

27. The process according to claim 26, wherein the at least one water-soluble vanadium compound comprises NaVO₃, (NH₄)VO₃ or a mixture thereof.

28. The process according to claim 26, wherein the aqueous solution of the at least one water-soluble vanadium compound is reacted with the source of Q and, where c does not equal zero, the source of M to form an intermediate process stream, and the intermediate process stream is continuously mixed with the solution of a silver salt to form a mixed product stream and the mixed product stream is spray-dried.

29. The process according to claim 27, wherein the aqueous solution of the at least one water-soluble vanadium compound is reacted with the source of Q and, where c does not equal zero, the source of M to form an intermediate process stream, and the intermediate process stream is continuously mixed with the solution of a silver salt to form a mixed product stream and the mixed product stream is spray-dried.

30. A precatalyst comprising an inert nonporous support material having a surface and a layer disposed on at least a portion of the surface, wherein the layer comprises a multimetal oxide according to claim 14.

31. The precatalyst according to claim 30, wherein the multimetal oxide is present in an amount of 5 to 25% by weight based on the precatalyst.

32. The precatalyst according to claim 30, wherein the inert nonporous support material comprises steatite.

33. A process for preparing a catalyst for gas phase partial oxidation of aromatic hydrocarbons, comprising:
(a) providing a precatalyst according to claim 30;
(b) heat-treating the precatalyst.
